(19) United States
(12) Patent Application Publication
(10) Pub. No.: US 2006/0109617 A1
(43) Pub. Date: May 25, 2006

(54) Touch pen holder and touch pen arrangement

(75) Inventors: Lii-Hwang Chen, Sanchong City (TW); Ping-Chih Chiang, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/992,704

(22) Filed: Nov. 22, 2004

(51) Int. Cl. G06F 1/16

(52) U.S. Cl. 361/683; 345/156

(57) ABSTRACT

A touch pen holder and touch pen arrangement is disclosed to include a touch pen, which has a shank and a positioning butt protruded from the periphery of the rear end of the shank, and a receptacle, which is mounted inside a shell of a portable electronic and which has a front opening, an elongated receiving chamber extending from the front opening toward the inside of the shell of the portable electronic device for receiving the touch pen, a beveled front surface extended around the front opening for guiding the positioning butt into a position inside the receptacle upon insertion of the touch pen into the elongated receiving chamber, and a crevice formed in the lowest point of the front opening along the beveled front surface and extending in axial direction for receiving the positioning butt of the touch pen.

### BACKGROUND OF THE INVENTION

1. Field of the Invention

The present invention relates to a touch pen holder structure and more particularly, to a touch pen holder and touch pen arrangement for portable electronic device.

2. Description of Related Art

A webpad is a newly developed high-tech product. People may compare a webpad to a laptop computer, tablet PC, or PDA (Personal Data Assistant). Generally, a laptop computer and a tablet PC have a relatively higher data processing power and better mobility than a desktop computer. A tablet PC provides an additional touch screen for handwrite data input. Regular laptop computers and tablet PCs are designed for general users. PDAs are concentrated on low-level word processing, for example, electronic address book or notebook for paper work. PDAs are also designed for general users.

A webpad is sending to the market as an electronic device between a laptop computer and a PDA. A webpad has a weight lighter than a laptop computer, and provides a touch-control data input function like a tablet PC. More particularly, a webpad provides a wireless LAN/Internet connection function. For example, when attached with a 802.11b network card, a webpad can have the complicated data computing work be handled by a remote host computer and can access data accurately and wirelessly at a high speed. Unlike laptop computers and PDAs for general users, webpads are designed for people working in specific fields such as hospitals, sales centers, distributors, schools, etc.

The structure of a webpad can be regarded as a laptop computer without top cover. It is based on a tablet PC formed of a LCD panel and a base member, providing a touch-control data input function. Touch-control data input can be done by means of the user's finger. However, for better accuracy, a touch pen is provided with a webpad for data input.

The touch pen receiving arrangement of a portable electronic device is not the key point of the device, however, it has a great concern with the efficiency of use of the portable electronic device. A touch pen that is easily accessible to the user is positive to the efficiency of use of the portable electronic device. Regular webpads, mobile telephones and other portable electronic devices that provide a touch pen for data entry commonly provide a simple penholder for holding the touch pen. However, the penholders of regular portable electronic devices are not orthopedically engineered for instant and rapid access.

### SUMMARY OF THE INVENTION

The present invention has been accomplished under the circumstances in view. It is therefore the main object of the present invention to provide a touch pen holder and touch pen arrangement for portable electronic device, which is orthopedically engineered for instant and rapid access.

To achieve this and other objects of the present invention, the touch pen holder and touch pen arrangement comprises a touch pen, and a receptacle. The touch pen has a shank and a positioning butt protruded from the periphery of the rear end of the shank. The receptacle is mounted inside a shell of a portable electronic, the receptacle having a front opening, an elongated receiving chamber extending from the front opening toward the inside of the shell of the portable electronic device for receiving the touch pen, a beveled front surface extended around the front opening for guiding the positioning butt of the touch pen into a position inside the receptacle upon insertion of the touch pen into the elongated receiving chamber, and a crevice formed in the lowest point of the front opening along the beveled front surface and extending in axial direction for receiving the positioning butt of the touch pen.

### BRIEF DESCRIPTION OF THE DRAWINGS

FIG. 1 is a schematic drawing of a webpad embodying the present invention.

FIG. 2 is an enlarged view of a part of the present invention.

FIG. 3 is a sectional view in an enlarged scale of a part of the present invention.

### DETAILED DESCRIPTION OF THE PREFERRED EMBODIMENT

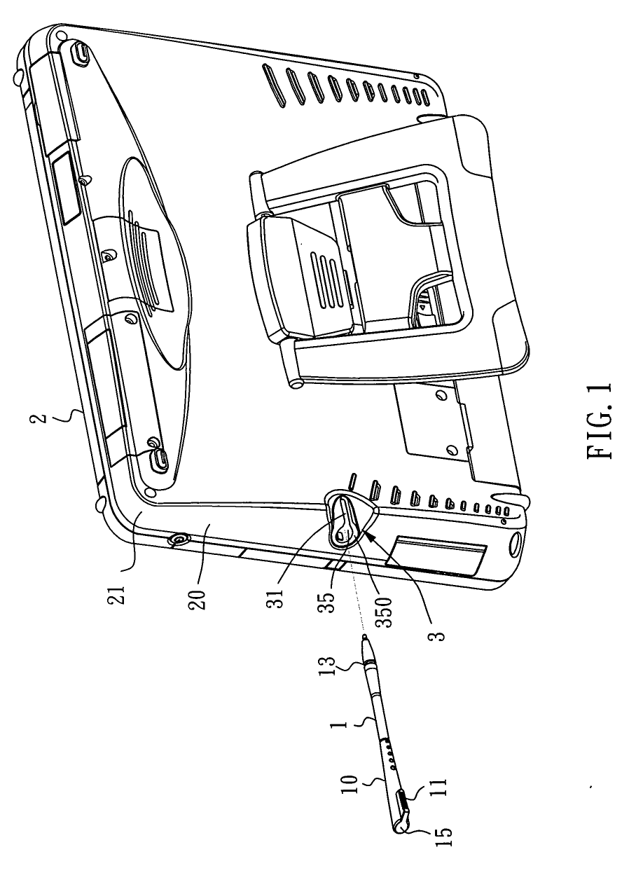

Referring to FIG. 1, a shell 2 for a webpad and a touch pen 1 are shown. The touch pen 1 comprises a cylindrical shank 10, which has a positioning butt 11 at the rear end thereof. The back panel 21 of the shell 2 of the webpad has a receptacle 3 mounted inside one side edge 20 thereof. The receptacle 3 has an opening 35 formed in the side edge 20, an elongated receiving chamber 211 extending from the opening 35 toward the inside of the shell 2, a beveled front surface 350 round the opening 35, an a crevice 31 formed in the lowest point of the opening 35 along the beveled front surface 350 and extending in axial direction.

According to the present preferred embodiment, the width of the crevice 31 is slightly greater than the positioning butt 11 of the touch pen 1 so that the cylindrical shank 10 of the touch pen 1 can be inserted through the opening 35 into the elongated receiving chamber 211, and the positioning butt 11 can be guided by the beveled front surface 350 into the crevice 31 and positioned in the crevice 31 upon insertion of the shank 10 into the receiving chamber 211.

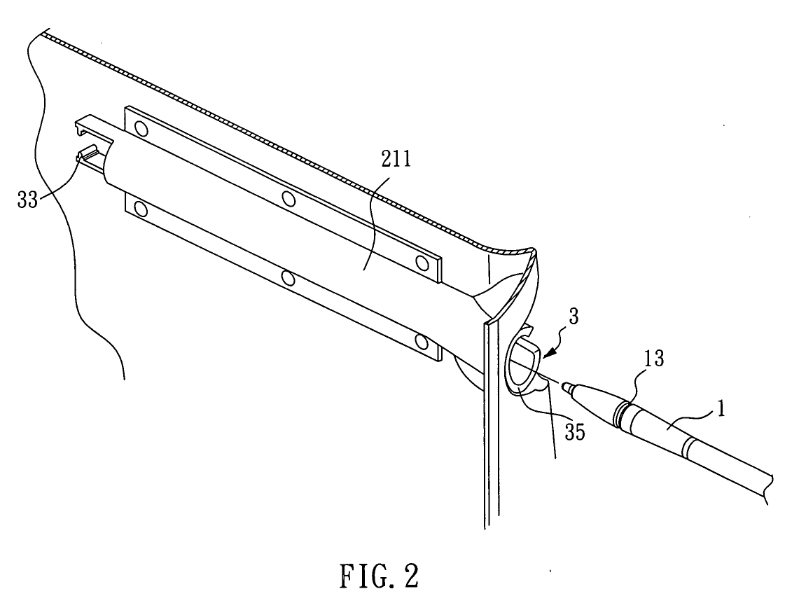

Referring to FIG. 2, the touch pen 1 has a positioning groove 13 extended around the periphery near the front end thereof; the receptacle 3 has positioning protrusions 33 disposed inside the elongated receiving chamber 211 near the front end thereof for engaging the positioning groove 13 to hold the touch pen 1 steadily in the receiving chamber 211 of the receptacle 3.

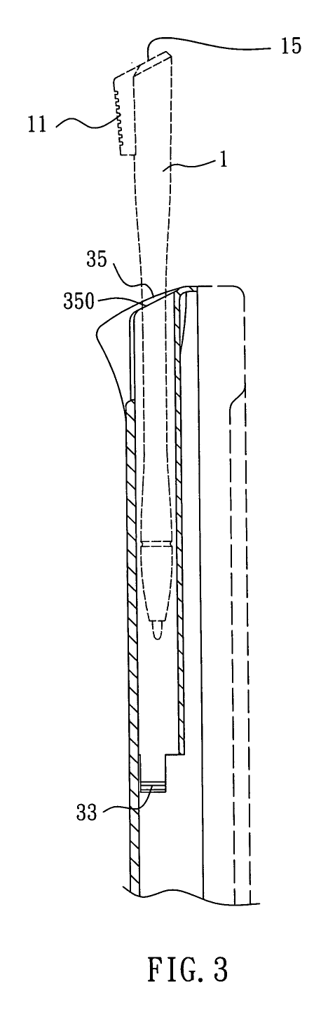

Referring to FIG. 3, when inserting the touch pen 1 into the receptacle 3 with the positioning butt 11 not in axial alignment with the crevice 31, the positioning butt 11 will be stopped at the beveled front surface 350 and then guided by the beveled front surface 350 into the crevice 31. Therefore, the touch pen 1 can easily be inserted into the receptacle 3 and steadily positioned therein. Further, the touch pen 1 has a beveled rear end 15. The slope of the beveled rear end 15 is equal to the beveled front surface 350. Therefore, when inserted the touch pen 1 into the inside of the receptacle 3, the touch pen 1 is completely received inside the receptacle 3 without any part protruding out of the beveled front surface 35. Further, the positioning butt 11 is preferably made having an anti-skip structure, for example, a wrinkled, corrugated, or smoothly inwardly curved surface that produces a friction resistance upon touch of the user's fingers to pull the touch pen 1 out of the receptacle 3. Therefore, the user can easily pull the touch pen 1 out of the receptacle 3.

According to the present preferred embodiment, the touch pen holder structure is employed to a webpad. Actually, the touch pen holder structure can also be employed to any of a variety of portable electronic devices such as PDA, laptop computer, electronic dictionary, and mobile cellular telephone. There is no limitation to the position of the receptacle 3 in the portable electronic device. Preferably, the receptacle 3 is provided at one lateral side of the shell of the portable electronic device. The positioning butt 11 can be made extending axially along the shank 10. Alternatively, the positioning butt 11 can be made in the form of a block. However, the length and width of the crevice 31 must fit the size of the positioning butt 11. Further, the anti-skip structure of the positioning butt 11 can be made in any of a variety of forms, for example, a wrinkled, corrugated, or smoothly inwardly curved surface. Preferably, the anti-skip structure is a wrinkled surface.

Although the present invention has been explained in relation to its preferred embodiment, it is to be understood that many other possible modifications and variations can be made without departing from the spirit and scope of the invention as hereinafter claimed.

What is claimed is:

1. A touch pen holder and touch pen arrangement comprising:
a touch pen, said touch pen having a shank and a positioning butt protruded from the periphery of a rear end of said shank; and
a receptacle mounted inside a shell of a portable electronic device, said receptacle having a front opening, an elongated receiving chamber extending from said front opening toward the inside of the shell of said portable electronic device for receiving said touch pen, a beveled front surface extended around said front opening for guiding the positioning butt of said touch pen into a position inside said receptacle upon insertion of said touch pen into said elongated receiving chamber, and a crevice formed in the lowest point of the front opening along said beveled front surface and extending in axial direction for receiving the positioning butt of said touch pen.

2. The touch pen holder and touch pen arrangement as claimed in claim 1, wherein said portable electronic device is a webpad.

3. The touch pen holder and touch pen arrangement as claimed in claim 1, wherein the positioning butt of said touch pen extends axially along said shank.

4. The touch pen holder and touch pen arrangement as claimed in claim 1, wherein the crevice of said receptacle has a length equal to the length of the positioning butt of said touch pen.

5. The touch pen holder and touch pen arrangement as claimed in claim 1, wherein said touch pen has a positioning groove extended around the periphery near a front end thereof; said receptacle has at least one protruding portion disposed inside said elongated receiving chamber near a front end thereof for engaging said positioning groove to hold said touch pen in position upon insertion of said touch pen into the elongated receiving chamber of said receptacle.

6. The touch pen holder and touch pen arrangement as claimed in claim 1, wherein the positioning butt of said touch pen has an anti-skip surface structure.
